(19) United States
(12) Patent Application Publication
(10) Pub. No.: US 2007/0215722 A1
(43) Pub. Date: Sep. 20, 2007

(54) Fertilizer dispensing device

(76) Inventors: Raymond A. Smith III, Henderson, NV (US); Terry Lee Moore, Las Vegas, NV (US)

Correspondence Address: ROBERT RYAN MORISHITA;MORISHITA LAW FIRM, LLC, 3800 HOWARD HUGHES PKWY,, SUITE 850, LAS VEGAS, NV, 89169, US

(21) Appl. No.: 11/378,679

(22) Filed: Mar. 17, 2006

(51) Int. Cl. A62C 13/62; B05B 7/04; B05B 7/12

(52) U.S. Cl. 239/398; 239/302; 239/409

(57) ABSTRACT

A device for dispensing fertilizer into a fluid flowing in a pipe includes a fertilizer tank and a coupling communicating with the pipe. Optionally, the tank includes a pressure gauge, a sight glass, and a fill port with a fitting that engages a fitting on a cap or a funnel. In an optional embodiment, the tank and coupling communicate through an in-flow tube and an out-flow tube. An in-flow inlet on the tank receives a flow of fluid through the coupling from the pipe. Fluid flowing into the tank forces fertilizer from the tank through an out-flow outlet that communicates with the coupling.

### FIELD OF THE INVENTION

The present invention is a fertilizer dispensing device. More specifically, the present invention is a flow-through fertilizer tank that dispenses fertilizer into a water system, such as a sprinkler or irrigation system.

### BACKGROUND OF THE INVENTION

The use of additive tanks to deliver additives to a water flow is known in the art. For example, some systems use an additive tank in which additive is held in a membrane. Water flows from the water source and squeezes the membrane. The additive is forced, under pressure, from the membrane and delivered to the water flow.

The drawback of this system is that the pressure on the membrane will vary, thereby varying the amount of additive delivered to the water flow. That is, the weight of the water pressing on the membrane will increase as more volume is delivered. Yet another drawback of such a system is that to refill the additive tank, additive must be added to the membrane or another filled membrane must be inserted into the tank.

Alternate methods of mixing additive into water flow include using the water flow to compress a piston to inject additive into the water flow, using the water flow to create a pressure differential to siphon additive from a tank, or relying on gravity to force additive from an additive tank.

One particular method that has not yet been successful is the flow-through tank. The flow-through tanks of the prior art often fail due to pressure lock. That is, flow is disrupted because insufficient pressure exists to force additive and fluid from the large tank through an outlet. Flow-through tanks of the prior art also tend to have uneven concentrations of additive in the fluid flowing out of the tank.

### SUMMARY OF THE INVENTION

The present invention is a device for dispensing fertilizer into a fluid flowing through a pipe. The device includes a coupling connected to the pipe such that the fluid flows substantially through the coupling. In an optional embodiment, the coupling connects to the pipe such that substantially all the fluid flowing in the pipe passes through the coupling. The coupling includes an in-feed port and an out-feed port. Optionally, the coupling includes a valve diverting a volume of the fluid flowing through the coupling to the in-feed port. In one version of such an optional embodiment, the volume of fluid diverted to the in-feed port is selected, i.e. increased or decreased, using the valve.

In one optional embodiment, the tank includes a fill port with a first fitting and a funnel with a second fitting adapted to mate with the first fitting is provided. In this manner, the funnel removably connects to the fill port through the mating fittings.

The tank may also include a sight glass. In such an optional embodiment, the sight glass communicates with the tank such that the quantity of fertilizer is displayed through the sight glass. For example, the sight glass could comprise a transparent tube oriented substantially vertically with one end of the tube proximate the top of the tank and one end of the tube proximate the bottom of the tank.

In yet a further optional embodiment, the tank may include a pressure gauge measuring the pressure of the fertilizer and fluid, if any, in the tank.

The device also includes a fertilizer tank storing fertilizer. Optionally, the fertilizer has a greater specific gravity than the fluid. The fertilizer tank includes an in-feed inlet in fluid communication with the in-feed port of the coupling and an out-feed outlet in fluid communication with the out-feed port of the coupling. The fluid flowing from the in-feed port of the coupling enters the tank through the in-feed inlet and a mixture of fluid and fertilizer flowing through the out-feed outlet enters the coupling through the out-feed port. Optionally, the mixture of fluid and fertilizer is drawn from a portion of the tank proximate the bottom.

In an optional embodiment, an in-feed tube connects the in-feed port of the coupling to the in-feed inlet of the tank. Similarly, in an optional embodiment, an out-feed tube connects to the out-feed port of the coupling and passes through the out-feed outlet so that an end of the out-feed tube rests inside the tank. For example, where the mixture of fluid and fertilizer is drawn from proximate the bottom of the tank, the out-feed tube may extend to, and/or rest on, the bottom of the tank. Optionally, the in-feed inlet and the out-feed port are push-in connectors that receive and engage the end of their respective tubes. In an optional embodiment, the in-feed port and the out-feed outlet is a push-through connector receiving and engaging their respective tubes at an intermediate point spaced from the ends of the tube.

### BRIEF DESCRIPTION OF THE DRAWINGS

FIG. 1 is a side view of a device according to an embodiment of the present invention;

FIG. 2 is a side view of a tank according to an embodiment of the present invention;

FIG. 3 is a side view of a tank with a funnel according to an embodiment of the present invention;

FIG. 4 is a side view of a coupling according to an embodiment of the present invention;

FIG. 5 is a side view of a coupling according to another embodiment of the present invention.

### DESCRIPTION

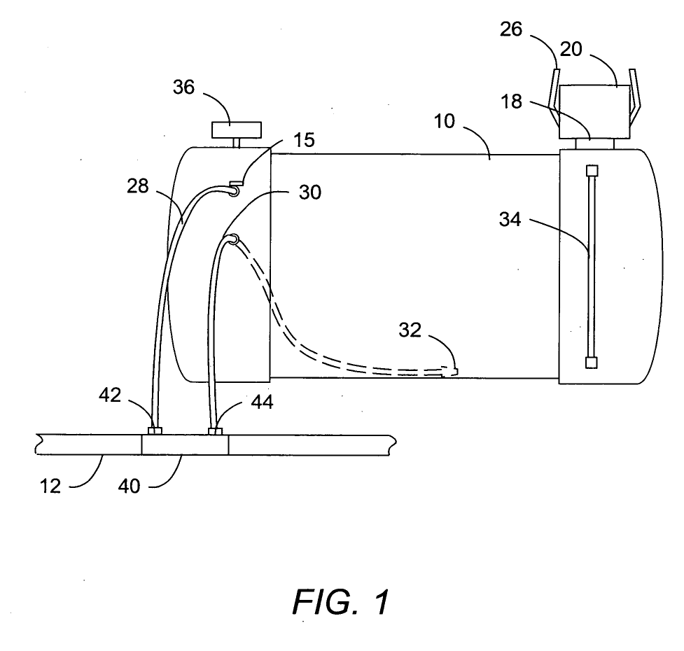

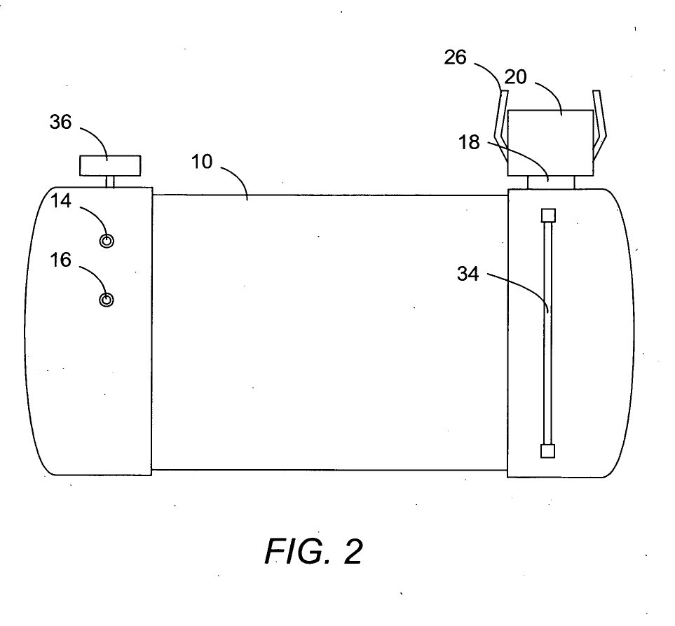

Reference is now made to the figures wherein like parts are referred to by like numerals throughout. Referring to FIGS. 1-5, the present invention is a device for introducing fertilizer into a fluid flowing in a pipe 12. Optionally, the fluid is water and the pipe is part 12 of a watering, sprinkler, or irrigation system. The device includes a fertilizer tank 10 with a storage volume defined by a tank surface. The tank 10 may take any shape. Optionally, the tank 10 has a top and a bottom defined by the direction of gravity.

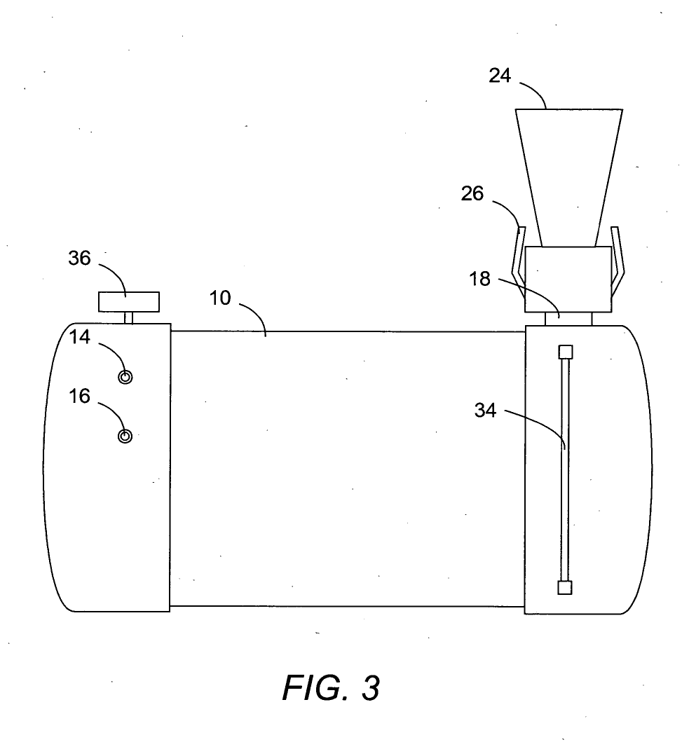

In an optional embodiment, the tank 10 includes a fill port 18 for adding fertilizer into the tank. In the optional embodiment illustrated in FIG. 3, the fill port 18 includes a first fitting that receives a cap 20, but also mates to a second fitting on a funnel 24. In this manner, the funnel 24 may be secured to the fill hole 18 by mating the second fitting to the first fitting. Optionally, the second fitting on the funnel (and optionally on a the cap) is a camlock fastener that includes latches 26 with cams to engage shoulders on a first fitting on the fill port 18.

Referring generally to FIGS. 1-5, the tank 10 includes an in-feed inlet 14 and an out-feed outlet 16. Optionally, the in-feed inlet 14 includes an in-feed valve 15 to control fluid flowing into the tank. In an optional embodiment, the in-feed inlet 14 and out-feed outlet 16 include fittings secured to, and passing through, the tank surface. The in-feed inlet 14 and out-feed outlet 16 are optionally a push-in connector and push-through connector, respectively. That is, in an optional embodiment, the in-feed inlet 14 receives and engages an end of a in-feed tube 28, while the out-feed outlet 16 allows an out-feed tube 30 to pass through the out-feed outlet 16 and into the storage volume of the tank 10. Optionally, the out-feed tube may include a filter 32, strainer, or other means for preventing solids into the out-feed tube. In an optional embodiment, the out-feed tube 30 reaches the bottom of the tank so that the mix of fertilizer and fluid passing through the out-feed tube 30, as described in greater detail below, is drawn from the bottom of the tank 10.

The tank may include a sight glass 34 in an optional embodiment. The sight glass 34 is substantially transparent and engages the fertilizer in the tank, thereby permitting visual inspection of the volume of fertilizer in the tank. While the sight glass 34 could merely be a window on the tank surface, in an optional embodiment, the sight glass 34 is a substantially transparent tube, oriented vertically along the tank 10, with one end passing through the tank surface near the top of the tank 10, and the other end passing through the tank surface near the bottom of the tank 10. In this manner, the volume of fertilizer in the tank 10 can be extrapolated from the level of fertilizer visible in the tube. As will be described in greater detail below, in an optional embodiment the fertilizer has a greater specific gravity than the fluid. Thus, the fertilizer, which may be different in color than the fluid, will be visible in the tube near the end passing through the tank surface near the bottom of the tank 10.

The tank 10 may also include a pressure gauge 36. The pressure gauge 36 optionally measures fluid pressure in the tank 10. As described in greater detail below, in an optional embodiment, substantially all of the flow from the tank 10 flows through the out-feed outlet 30. Thus, the fluid pressure in the tank 10 is indicative of the volume flow of fluid into, and fluid and fertilizer mixture out of, the tank 10.

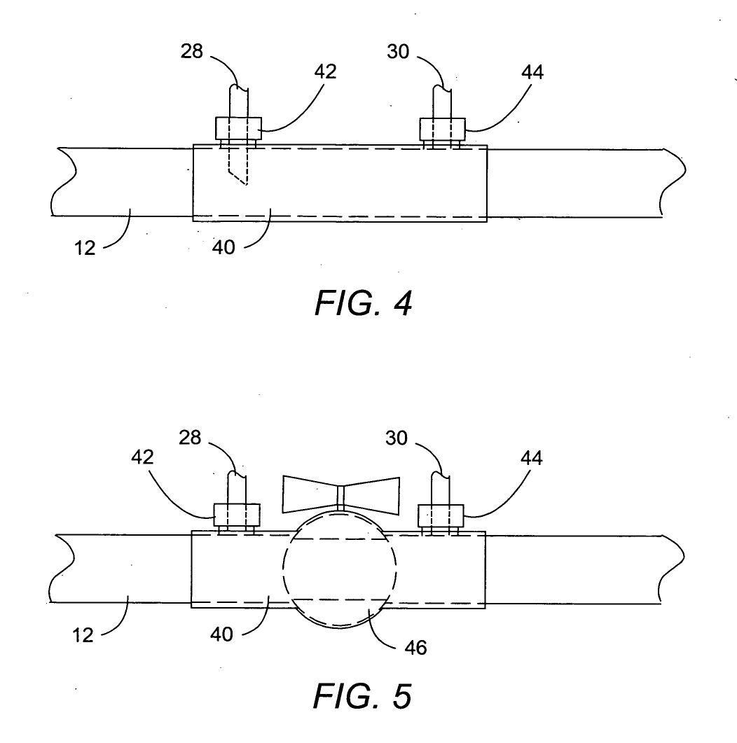

The device also includes a coupling 40. The coupling 40 includes an in-feed port 42 and an out-feed port 44. The in-feed port 40 of the coupling communicates with the in-feed inlet 14 of the tank 10. Similarly, the out-feed port 44 of the coupling communicates with the out-feed outlet 16 of the tank 10. As noted above, this communication could occur through an in-feed tube 28 and out-feed tube 30, respectively. In an optional embodiment, shown in FIG. 4, the in-feed port 42 and out-feed port 44 are fittings, such as a push-through connector and push-in connector respectively. In this optional embodiment, the in-feed tube 28 may extend into the pipe 12 and include an angled end to direct fluid flow in the pipe 12 to through the in-flow tube 28 and through the in-flow port 42. In another optional embodiment, shown in FIG. 5 and described in greater detail below, both the in-feed port 42 and out-feed port 44 may be fittings, such as push-in connectors, that engage the end of their respective tubes. In such an optional embodiment, a valve 46 directs the fluid flow into the in-flow tube 28 and through the in-flow port 42.

The coupling 40 engages the pipe 12 so that at least a portion of the fluid flowing in the pipe 12 flows through the coupling 40. In an optional embodiment, substantially all the fluid flowing in the pipe 12 flows through the coupling 40. In any event, the coupling 40 diverts at least a portion of the fluid flowing in the pipe 12 to the in-feed port 42. In an optional embodiment, the amount diverted is selectable, such as through a valve 46. For example, in one such optional embodiment, the coupling includes a ball valve, such as a slip ball valve, that can selectively divert none, some, or all of the fluid flow through the coupling 40 to the in-feed port 42.

In use, at least some fluid flowing through the pipe 12 passes through the coupling 40 and is diverted to the in-feed port 42. As mentioned above, the volume of fluid diverted to the in-feed port 42 may be selectable by the user through a valve 46. The fluid passing to the in-feed port 42 travels to the in-feed inlet 14, optionally through an in-feed tube 28 connecting the in-feed port 42 and the in-feed inlet 14. The fluid passing through the in-feed inlet 14 enters the tank 10.

In an optional embodiment in which the fertilizer has a greater specific gravity than the fluid, the fluid tends to collect near the top of the tank 10, although it is contemplated that some mixing will occur. In such an optional embodiment, pressure of the fluid flowing into the tank 10 drives the contents of the tank, i.e. a mixture containing fertilizer and fluid, to the out-flow outlet 16. As mentioned above, in an optional embodiment, to reach the out-flow outlet 16, the fluid may pass through the out-flow tube 30 disposed in the tank 10.

The mixture is communicated from the out-flow outlet 16 to the out-flow port 44 of the coupling 40, optionally through an out-flow tube 30. The mixture enters the coupling 40 and is delivered through the pipe 12. As noted above, the pipe 12 may be part of a watering, sprinkler, or irrigation system. Thus, the mixture is delivered by the pipe 12 to the nozzle, sprinkler, spigot, or other outlet for the pipe 12.

While certain embodiments of the present invention have been shown and described it is to be understood that the present invention is subject to many modifications and changes without departing from the spirit and scope of the claims presented herein.

I claim:

1. A device for dispensing fertilizer into a fluid flowing through a pipe, comprising:
a coupling connected to said pipe such that said fluid flows substantially through said coupling, said coupling including an in-feed port and an out-feed port; and
a fertilizer tank storing fertilizer, said fertilizer having a greater specific gravity than said fluid, said fertilizer tank including an in-feed inlet in fluid communication with said in-feed port of said coupling and an out-feed outlet in fluid communication with said out-feed port of said coupling such that fluid flowing from said in-feed port enters said tank through said in-feed inlet and a mixture of fluid and fertilizer flowing through said out-feed outlet enters said coupling through said out-feed port.

2. The device of claim 1 wherein said tank includes a fill port with a first fitting, said device further comprising a funnel with a second fitting adapted to mate with said first fitting such that said funnel removably connects to said fill port.

3. The device of claim 1 wherein said device further comprises a sight glass communicating with said tank such that the quantity of fertilizer is displayed through said sight glass.

4. The device of claim 3 wherein said tank has vertical height defined by a top and bottom and said sight glass comprises a transparent tube having two ends, wherein said tube is oriented substantially vertically with one end of said tube proximate said top of said tank and one end of said tube proximate said bottom of said tank.

5. The device of claim 1 further comprising a pressure gauge measuring the pressure of said fertilizer and fluid, if any, in said tank.

6. The device of claim 1 further comprising:
an in-feed tube having two ends, one end of said in-feed tube connected to said in-feed port of said coupling and the other end of said in-feed tube connected to said in-feed inlet; and
an out-feed tube having two ends, one end of said out-feed tube connected to said out-feed port of said coupling and said out-feed tube passing through said out-feed outlet such that the other end of said out-feed tube rests inside said tank.

7. The device of claim 6 wherein said in-feed port and said in-feed inlet are push-in connectors receiving and engaging said ends of said in-feed tube, said out-feed port is a push-in connector receiving and engaging one end of said out-feed tube, and said out-feed outlet is a push through connector receiving and engaging said out-feed tube spaced from said other end of said out-feed tube.

8. A device for dispensing fertilizer into a fluid flowing through a pipe, comprising:
a coupling connected to said pipe such that all said fluid flowing through said pipe flows substantially through said coupling, said coupling including an in-feed port and an out-feed port, said coupling including a valve diverting a volume of said fluid flowing through said coupling to said in-feed port such that the volume of fluid diverted is selected through said valve; and
a fertilizer tank storing fertilizer, said fertilizer having a greater specific gravity than said fluid, said fertilizer tank including an in-feed inlet in fluid communication with said in-feed port of said coupling and an out-feed outlet in fluid communication with said out-feed port of said coupling such that fluid flowing from said in-feed port enters said tank through said in-feed inlet and a mixture of fluid and fertilizer flowing through said out-feed outlet enters said coupling through said out-feed port.

9. The device of claim 8 wherein said tank includes a fill port with a first fitting, said device further comprising a funnel with a second fitting adapted to mate with said first fitting such that said funnel removably connects to said fill port.

10. The device of claim 8 wherein said device further comprises a sight glass communicating with said tank such that the quantity of fertilizer is displayed through said sight glass.

11. The device of claim 10 wherein said tank has vertical height defined by a top and bottom and said sight glass comprises a transparent tube having two ends, wherein said tube is oriented substantially vertically with one end of said tube proximate said top of said tank and one end of said tube proximate said bottom of said tank.

12. The device of claim 8 further comprising a pressure gauge measuring the pressure of said fertilizer and fluid, if any, in said tank.

13. The device of claim 8 further comprising:
an in-feed tube having two ends, one end of said in-feed tube connected to said in-feed port of said coupling and the other end of said in-feed tube connected to said in-feed inlet; and
an out-feed tube having two ends, one end of said out-feed tube connected to said out-feed port of said coupling and said out-feed tube passing through said out-feed outlet such that the other end of said out-feed tube rests inside said tank.

14. The device of claim 13 wherein said in-feed port and said in-feed inlet are push-in connectors receiving and engaging said ends of said in-feed tube, said out-feed port is a push-in connector receiving and engaging one end of said out-feed tube, and said out-feed outlet is a push through connector receiving and engaging said out-feed tube spaced from said other end of said out-feed tube.

15. A device for dispensing fertilizer into a fluid flowing through a pipe, comprising:
a coupling connected to said pipe such that all said fluid flowing through said pipe flows substantially through said coupling, said coupling including an in-feed port and an out-feed port, said coupling including a valve diverting a volume of said fluid flowing through said coupling to said in-feed port such that the volume of fluid diverted is selected through said valve; and
a fertilizer tank storing fertilizer, said fertilizer having a greater specific gravity than said fluid, said fertilizer tank including an in-feed inlet in fluid communication with said in-feed port of said coupling and an out-feed outlet in fluid communication with said out-feed port of said coupling such that fluid flowing from said in-feed port enters said tank through said in-feed inlet and a mixture of fluid and fertilizer flowing through said out-feed outlet enters said coupling through said out-feed port, said tank having a vertical height defined by a top and a bottom of said tank such that said out-feed port draws said mixture of fluid and fertilizer from a location in said tank proximate said bottom.

16. The device of claim 15 wherein said tank includes a fill port with a first fitting, said device further comprising a funnel with a second fitting adapted to mate with said first fitting such that said funnel removably connects to said fill port.

17. The device of claim 15 wherein said device further comprises a sight glass communicating with said tank such that the quantity of fertilizer is displayed through said sight glass.

18. The device of claim 17 wherein said tank has vertical height defined by a top and bottom and said sight glass comprises a transparent tube having two ends, wherein said tube is oriented substantially vertically with one end of said tube proximate said top of said tank and one end of said tube proximate said bottom of said tank.

19. The device of claim 15 further comprising a pressure gauge measuring the pressure of said fertilizer and fluid, if any, in said tank.

20. The device of claim 15 further comprising:
an in-feed tube having two ends, one end of said in-feed tube connected to said in-feed port of said coupling and the other end of said in-feed tube connected to said in-feed inlet; and
an out-feed tube having two ends, one end of said out-feed tube connected to said out-feed port of said coupling and said out-feed tube passing through said out-feed outlet such that the other end of said out-feed tube rests inside said tank proximate said bottom.

21. The device of claim 20 wherein said in-feed port and said in-feed inlet are push-in connectors receiving and engaging said ends of said in-feed tube, said out-feed port is a push-in connector receiving and engaging one end of said out-feed tube, and said out-feed outlet is a push through connector receiving and engaging said out-feed tube spaced from said other end of said out-feed tube.
